(19) United States
(12) Patent Application Publication
(10) Pub. No.: US 2016/0196544 A1
(43) Pub. Date: Jul. 7, 2016

(54) METHOD AND APPARATUS FOR ELECTRONIC PAYMENT AND AUTHENTICATION

(71) Applicant: Blackbird Technology Holdings, Inc., Dover, DE (US)

(72) Inventor: John Peter Norair, San Francisco, CA (US)

(21) Appl. No.: 14/997,001

(22) Filed: Jan. 15, 2016

Related U.S. Application Data
(63) Continuation of application No. 14/870,258, filed on Sep. 30, 2015.
Application No. 14/870,258 is a continuation of application No. 13/289,054, filed on Nov. 4, 2011, now abandoned.
(60) Provisional application No. 61/456,271, filed on Nov. 4, 2010.

(51) Int. Cl. G06Q 20/32; G06Q 20/40; G06Q 20/38

(52) U.S. Cl. CPC G06Q 20/322; G06Q 20/382; G06Q 20/40

(57) ABSTRACT

A first device may be operable to receive a request to accept a payment via an ISO 18000-7 interface. The first device may transmit, via the ISO 18000-7 interface, a wake-up message to a second device comprising an ISO 18000-7 interface. The first device may transmit, via the ISO 18000-7 interface, an authorization request to the second device. The first device may receive an authorization message from the second device. The first device may decide whether to accept the payment based on the received authorization message. The first device may register with a retail outlet's network upon coming into range of a registration terminal of the network. While registered with the network, the first device may communicate with the network utilizing the ISO 18000-7 interface. The first device may deregister with the network upon coming into range of a deregistration terminal of the network.

### CLAIM OF PRIORITY

This patent application is a continuation of U.S. Non-Provisional application Ser. No. 14/870,258 which was filed on Sep. 30, 2015, which is a continuation of U.S. Non-Provisional application Ser. No. 13/289,054 which was filed on Nov. 4, 2011, and which claims priority to U.S. Provisional Application Ser. No. 61/456,271 filed on Nov. 4, 2010, now expired.

The above-referenced applications are hereby incorporated herein by reference in their entirety.

### INCORPORATION BY REFERENCE

This patent application also makes reference to:

U.S. Provisional Patent Application No. 61/464,376 filed on Mar. 2, 2011;
U.S. patent application Ser. No. 13/267,640 filed on Oct. 6, 2011;
U.S. patent application Ser. No. 13/267,621 filed on Oct. 6, 2011;
U.S. patent application Ser. No. 13/270,802 filed on Oct. 11, 2011; and
U.S. patent application Ser. No. 13/270,959 filed on Oct. 11, 2011

Each of the above-referenced applications is hereby incorporated herein by reference in its entirety.

### FIELD OF THE INVENTION

Certain embodiments of the invention relate to communications. More specifically, certain embodiments of the invention relate to a method and apparatus electronic payment and authentication.

### BACKGROUND OF THE INVENTION

Existing methods of electronic payment and authentication are limited in terms of security, functionality, and flexibility. Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for electronic payment and authentication, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

FIG. 1 depicts an exemplary communication system comprising a multi-band, multi-mode communication device.

FIG. 2 depicts an exemplary multi-band, multi-mode communication device.

FIG. 3 depicts an exemplary memory partitioning in a multi-band, multi-mode communication device.

FIG. 4 is a diagram of an exemplary multi-band, multi-mode communication device.

FIG. 5A illustrates devices operable to carry out a retail transaction.

FIG. 5B is a flowchart illustrating steps of an exemplary financial transaction depicted in FIG. 5A.

FIG. 5C is a flowchart illustrating steps of an exemplary financial transaction depicted in FIG. 5A.

FIG. 6A illustrates an exemplary electronic financial transaction, in accordance with an embodiment of the invention.

FIG. 6B is a flowchart illustrating exemplary steps of the financial transaction depicted in FIG. 6A.

FIG. 7A depicts exemplary communications with a network of a retail outlet, in accordance with an embodiment of the invention.

FIG. 7B depicts exemplary communications with a network of a retail outlet, in accordance with an embodiment of the invention.

### DETAILED DESCRIPTION OF THE INVENTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be implemented in hardware, software, firmware, or any combination of one or more thereof. As utilized herein, the term “exemplary” means serving as a non-limiting example, instance, or illustration. As utilized herein, the terms “e.g.” and “for example” introduces a list of one or more non-limiting examples, instances, or illustrations.

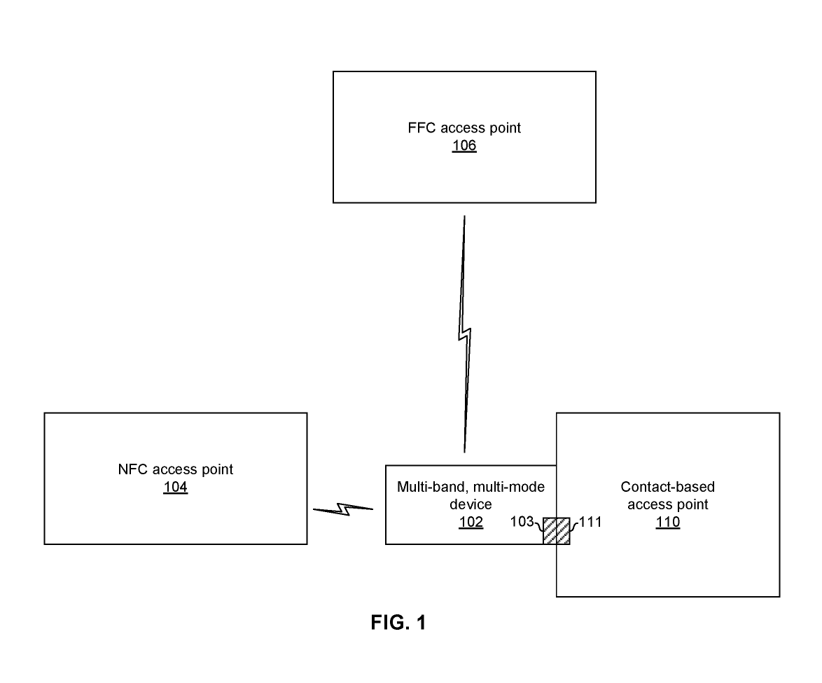

FIG. 1 depicts an exemplary communication system comprising a multi-band, multi-mode communication device. Shown in FIG. 1 is a multi-mode, multi-band communication device 102, a near-field communications (NFC) access point (AP) 104, a far-field communications (FFC) access point (AP) 106, and a contact-based communications (CCB) access point (AP) 110.

The NFC AP 104 may comprise circuitry operable to communicate in accordance with one or more near-field communication protocols. For example, the NFC AP 104 may comprise a radio operable to communicate in accordance with protocols specified in one or more of: ISO 18092, ISO 14443, and ISO 18000-3.

The FFC AP 106 may comprise circuitry operable to communicate in accordance with one or more far-field communication protocols. For example, the NFC AP 104 may comprise a radio operable to communicate in accordance with protocols specified in ISO 18000-7 and/or in the above-incorporated U.S. Provisional Patent Application 61/464,376 filed on Mar. 2, 2011.

The CBC AP 110 may comprise circuitry, including metal contact(s) 111, operable to communicate via the metal contact(s) 111. For example, the CBC AP 104 may comprise a radio operable to communicate in accordance with specifications set forth in ISO 7816.

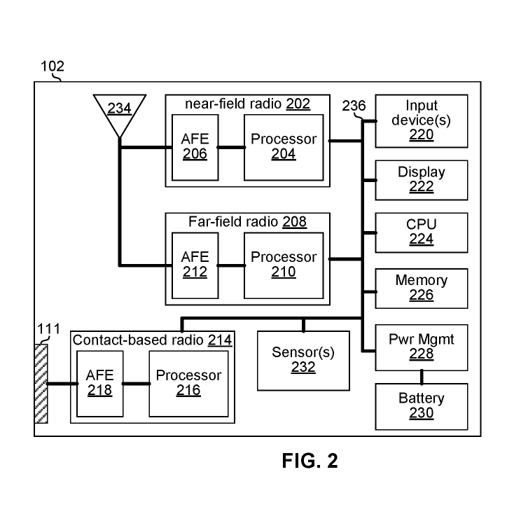

The multi-mode, multi-band communication device 102 may comprise circuitry operable to communicate in accordance with one or more far-field communication protocols (e.g., ISO 18000-7), one or more near-field communication protocols (e.g., ISO 18092, and/or ISO 14443), and one or more contact-based communication protocols (e.g., ISO 7816) via the contact(s) 103. In an exemplary embodiment of the invention, the communication device 102 may be a smartcard having physical dimensions in compliance with ISO 7816. In various other exemplary embodiments, the communication device 102 may be a keyfob, a tag, jewelry, or a wallet. Details of an exemplary communication device 102 are described below with respect to FIG. 2.

In operation, the communication device 102 may communicate with any one or more of the NFC AP 104 the FFC AP 106 and CBC AP 110. The communication device 102 may communicate with two or more of the access points sequentially and/or concurrently. The communication device 102 may, for example, communicate with different access points to perform different tasks and/or communicate different information. The communication device 102 may, for example, communicate with multiple access points to improve security of communications and/or reliability of communications.

FIG. 2 depicts an exemplary multi-band, multi-mode communication device. The exemplary communication device 102 comprises a near-field radio 202, a far-field radio 208, a contact-based radio 214, input device(s) 220, a display 222, a central processing unit (CPU) 224, a memory 226, a power management module 228, a battery 230, one or more sensors 232, and an antenna 234.

The near-field radio 202 may comprise circuitry operable to communicate in accordance with one or more near-field communication protocols. For example, the near-field radio 202 may comprise an analog front-end (AFE) 206 and a processor 204 operable to communicate in accordance with one or more near-field protocols (e.g., protocols specified in ISO 18092, ISO 14443, and/or ISO 18000-3). The processor 204 may comprise circuitry operable to interface with the AFE 206 to receive and transmit data, and to process received and to-be-transmitted data. For transmission, the processor 204 may be operable to receive data via the bus 236, packetize and/or otherwise process the data to prepare it for transmission in accordance with one or more near-field protocols, and output the data to the AFE 206 for transmission. For reception, the processor 204 may be operable to receive data via the AFE 206, process the received data and output received data onto the bus 236.

The far-field radio 208 may comprise circuitry operable to communicate in accordance with one or more near-field communication protocols. For example, the far-field radio 208 may comprise an analog front-end (AFE) 212 and a processor 210 operable to communicate in accordance with one or more far-field protocols (e.g., protocols specified in ISO 18000-7 and/or in the above-incorporated U.S. Provisional Patent Application 61/464,376 filed on Mar. 2, 2011). The processor 210 may comprise circuitry operable to interface with the AFE 212 to receive and transmit data, and to process received and to-be-transmitted data. For transmission, the processor 210 may be operable to receive data via the bus 236, packetize and/or otherwise process the data to prepare it for transmission in accordance with one or more far-field protocols (e.g., protocols specified in ISO 18000-7 and/or in the above-incorporated United States Provisional Patent Application 61/464,376 filed on Mar. 2, 2011), and output the data to the AFE 212 for transmission. For reception, the processor 210 may be operable to receive data via the AFE 212, process the received data and output received data onto the bus 236.

The contact-based radio 214 may comprise circuitry operable to communicate in accordance with one or more near-field communication protocols. For example, the contact-based radio 214 may comprise an analog front-end (AFE) 218 and a processor 216 operable to communicate in accordance with one or more near-field protocols (e.g., protocols specified in ISO 7816). The processor 216 may comprise circuitry operable to interface with the AFE 218 to receive and transmit data, and to process received and to-be-transmitted data. For transmission, the processor 216 may be operable to receive data via the bus 236, packetize and/or otherwise process the data to prepare it for transmission in accordance with one or more near-field protocols, and output the data to the AFE 218 for transmission. For reception, the processor 216 may be operable to receive data via the AFE 218, process the received data and output received data onto the bus 236.

The input device(s) 220 may comprise circuitry operable to receive input from a user of the device 102 and convert the input to digital signals. For example, the input device(s) 220 may comprise one or more hard and/or soft buttons and/or a touchscreen.

The display 222 may comprise circuitry operable to output visual signals to a user of the communication device 102. For example, the display 222 may be an OLED or bistable electrophoretic type display.

The CPU 224 may comprise circuitry operable to control operation of the first device 102. The CPU 224 may, for example, execute an operating system and/or other programs. The CPU 224 may generate one or more control signals for controlling the operation of the device 102. The CPU 224 may, for example, control a mode of operation of the device 102.

Circuitry of the memory 226 may comprise one or more memory cells and may be operable to store data to the memory cell(s) and read data from the memory cell(s). The one or more memory cells may comprise one or more volatile memory cells and/or one or more non-volatile memory cells.

The power management module 228 may comprise circuitry operable to manage power allocation and/or power consumption in the communication device 102. The power management module 228 may be operable to, for example, dim and/or turn off the display when it is not needed, turn off one or more of the sensors 232 when not needed, and/or turn off the input device(s) 220 when not needed. Additionally and/or alternatively, the power management module 208 may control charging of the battery 230. For example, the power management module 208 may comprise an energy harvesting circuitry (e.g., to harvest solar energy, kinetic energy, and/or energy inductively coupled to the power management module 228) for charging the battery 208 and/or powering various components of the communication device 102. Additionally and/or alternatively, the power management module 208 may be operable to charge the battery 208 and/or power various components of the communication device 102 via energy received via the contacts 111. In an exemplary embodiment of the invention, certain components and/or functions of the communication device 102 may be disabled when the communication device 102 is not receiving power via, for example, inductive coupling and/or the contact(s) 111, and may be enabled when the communication device 102 is receiving power via, for example, inductive coupling and/or the contact(s) 111.

The battery 230 may, for example, a thin film and/or coin cell battery. In an exemplary embodiment of the invention, the battery may be as described in the above-incorporated U.S. Provisional Patent Application 61/404,842 filed on Oct. 12, 2010.

The sensor(s) 232 may comprise one or more of: an acoustic sensor operable to sense, e.g., amplitude, phase, polarization, spectrum and/or wave velocity of acoustic waves; a chemical operable to sense, e.g., the presence of any one or more elements and/or compounds in solid, gas, and/or liquid form; an electrical sensor operable to detect, e.g., amplitude, phase, polarization, and/or spectrum of a current and/or voltage, conductivity, and/or permittivity; a magnetic sensor operable to, e.g., detect flux, permeability, amplitude, phase, and/or polarization of a magnetic field; a mechanical sensor operable to detect, e.g., position, acceleration, force, stress, pressure, strain, mass, density, moment, torque, shape, roughness, orientation, and/or stiffness; an optical sensor operable to detect, e.g., amplitude, phase, polarization, and/or spectrum of an optical wave, wave velocity, refractive index, emissivity, reflectivity, and/or absorption; and/or a thermal sensor operable to detect, e.g., temperature, flux, specific heat, and/or thermal conductivity. The sensor(s) 232 may, for example, generate an interrupt to the CPU 224 when an alarm condition is present.

The antennas 234 may be operable to transmit and receive electromagnetic signals in one or more frequency bands. In an embodiment of the invention, the antenna 234 may be operable to transmit and receive signals in the ISM frequency band centered at 433.92 MHz and in the ISM frequency band centered at 13.56 MHz.

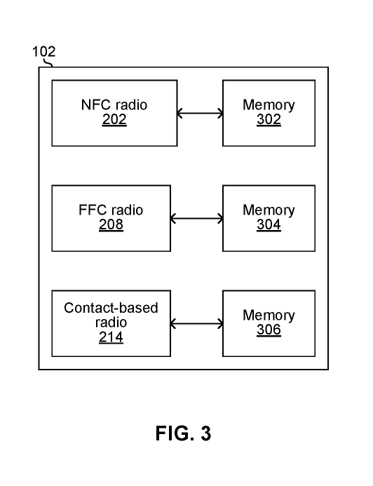

FIG. 3 depicts an exemplary memory partitioning in a multi-band, multi-mode communication device. Shown in FIG. 3 is the NFC radio 202, the FFC radio 208, the contact-based radio 214, and three portions of memory 302, 304, and 306. The portions of memory 302, 304, and 306 may correspond to logical and/or physical partitions of the memory 226. In an exemplary embodiment of the invention, data stored in the memory portion 302 may only be accessible via the NFC radio 202, data stored in the memory portion 304 may only be accessible via the FFC radio 208, and data stored in the memory portion 306 may only be accessible via the contact-based radio 214.

Partitioning of the memory may enable increased security for the communication device 102. In an exemplary embodiment, a first portion of a secure message may be stored in the first memory portion 302, a second portion of the secure message may be stored in the second memory portion 304, and neither portion may be useful without the other. In such an embodiment, to obtain the secure data, a device may need to communicate with the communication device via both the NFC radio and the FFC radio. In another exemplary embodiment, security data for authenticating and/or authorizing a communication may be stored in a first of the memory portions 302, 304, and 306 and general data may be stored in a second of the memory portions 302, 304, and 306. In such an embodiment, a communication device may need to be authenticated and/or authorized via a first of the radios 202, 208, and 214 before it can obtain data via a second one of the radios 202, 208, and 214.

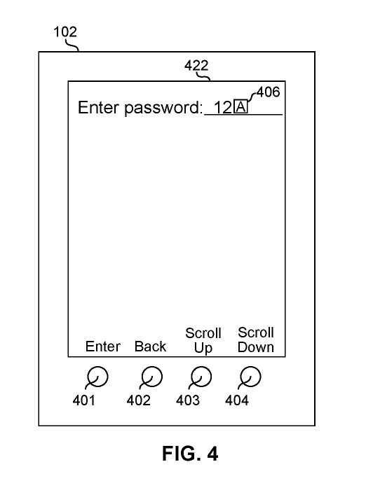

FIG. 4 is a diagram of an exemplary multi-band, multi-mode communication device. The exemplary device 102 shown in FIG. 4 may be as described above with respect to FIGS. 1-3. The device 102 comprises a screen 422 (e.g., the display 222 of FIG. 2) and a plurality of buttons 401-404. In an exemplary embodiment of the invention in which the device 102 is a smartcard, or other low-complexity device, the screen 422 may be a simple text-only display and the buttons may be “blister” buttons. The user may, for example, enter text by scrolling through an alphanumeric list using buttons 403 and 404, entering the text using button 401 and deleting text using button 402. Other user interfaces comprising other numbers and/or types of inputs may of course also be utilized. In an exemplary embodiment of the invention in which the device 102 is a smartphone, or other high-complexity device, the screen 422 may, for example, be a touchscreen and the device 102 may support a more advanced user interface.

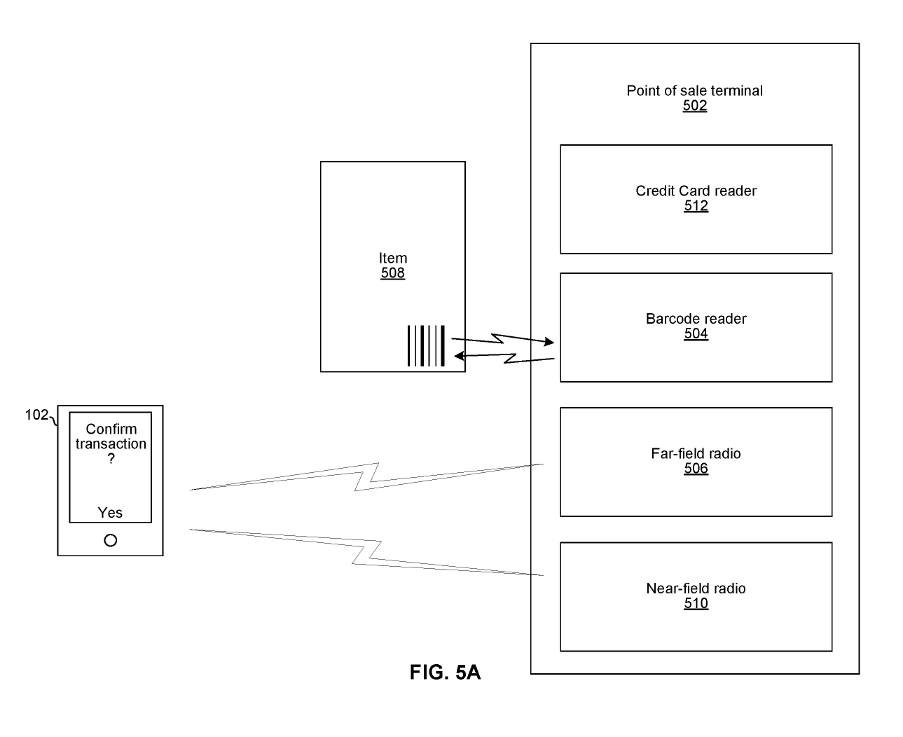

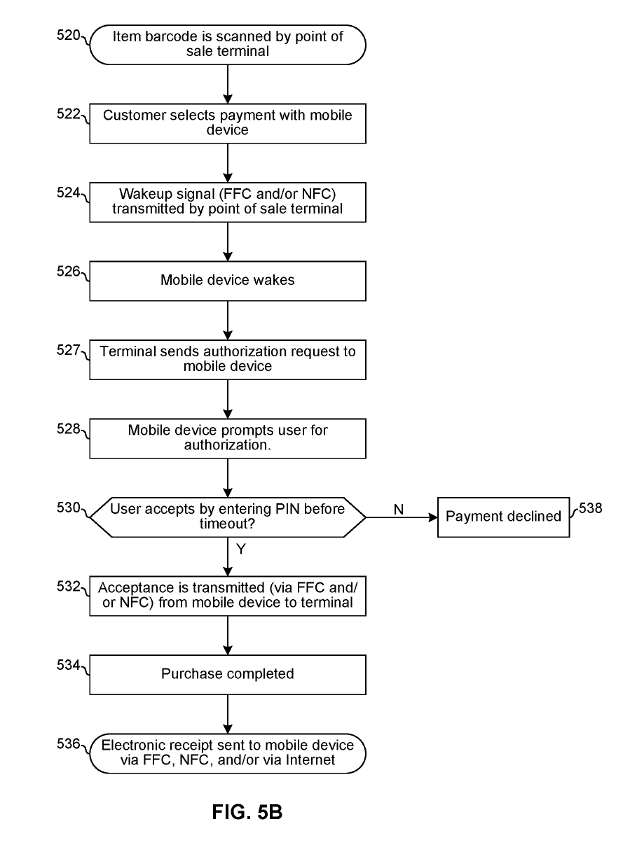

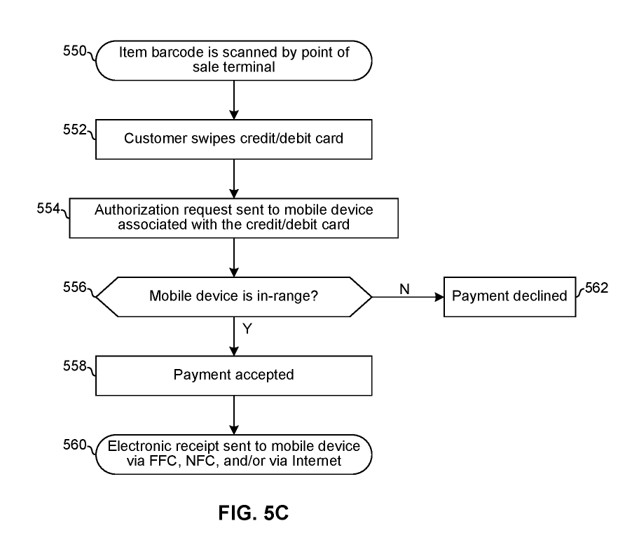

FIG. 5A illustrates devices operable to carry out a retail transaction. Shown in FIG. 5A is a point-of-sale terminal 502, an item 508 being purchased, and the communication device 102. Of course, item 508 may comprise a product, a representation of a service to be provided, or anything else that is being offered for sale.

The communication device 102 may be as described above with respect to FIGS. 1-4. The exemplary point-of-sale terminal 502 comprises a credit card reader 512, a barcode reader 504, a far-field radio 506, and a near-field radio 510. The far-field radio 506 may be similar to the far-field radio 208 described above with respect to FIG. 2. The near-field radio 510 may be similar to the near-field radio 202 described above with respect to FIG. 2. The credit card reader 512 may be operable to read the magnetic strip of a credit card, and communicate with the credit card company to determine whether to accept payment via the credit card. The barcode reader 504 may be operable to optically scan a barcode and use the barcode to retrieve pricing and/or other information about the item 508 from a database.

An exemplary transaction performed by the devices depicted in FIG. 5A will now be described with reference to the flowchart of FIG. 5B.

In step 520, the barcode of the item 508 is scanned by the barcode reader 504. In step 522, the customer purchasing the item 508 selects “pay with wireless device” on the point-of-sale terminal 502. In step 524, the point-of-sale terminal 502 transmits a wake-up signal to wake a nearby wireless device. The wake-up signal may be sent by the far-field radio 506 and/or the near-field radio 510. In an exemplary embodiment of the invention, the wake-up signal may be a “wake on” signal as set forth in the ISO 18000-7 standard. The strength and/or directivity of the wake-up signal may be controlled such that it only awakes devices within a particular location (e.g., a small area in front of the point-of-sale terminal 502).

In step 526, the device 102 may awake in response to the wake-up signal. In step 527, the point-of-sale terminal may send an authorization request to the device 102. The authorization request may contain information about the transaction (e.g., description of the item, its price, and the location of the transaction). In step 528, the device 102 may prompt its user for authorization. For example, the screen 222 may display a message: “purchase item 508 from retail store x?” The user may authorize the transaction by, for example, entering a PIN into the device 102. In step 530, if the user does not enter the correct PIN, then in step 538 the transaction may be cancelled (i.e., the payment is declined). If the user does enter the correct PIN, then in step 532 the device 102 may send a message authorizing the payment. The authorization message may be send via the far-field radio 208 and/or the near-field radio 510 of the device 102.

In step 534, upon receiving the payment authorization, the point-of-sale terminal 502 may complete the transaction. In step 536, the point-of-sale terminal 502 may send a record of the transaction to the device 102 and/or to an account (e.g., an email account) associated with the device 102. For example, the authorization message from the device 102 may include an email address to which the receipt is to be sent. The receipt may be sent via the far-field radio 506, the near-field radio 510, and/or via another network connection (e.g., an Ethernet port of the point-of-sale terminal 502). In an exemplary embodiment of the invention, the receipt may be stored online and a cookie which enables access to the receipt may be sent to the device 102 via the far-field radio 506 and/or the near-field radio 510. For example, the cookie may comprise a unique confirmation number which can be entered into the retail outlet's website to retrieve the receipt.

Another exemplary transaction performed by the devices depicted in FIG. 5A will now be described with reference to the flowchart of FIG. 5C.

In step 550, the barcode of the item 508 is scanned by the barcode reader 504. In step 552, the customer purchasing the item 508 selects “pay with credit/debit” on the point-of-sale terminal 502 and slides his credit/debit card. In step 554, the point-of-sale terminal 502 may perform a look-up to determine a wireless device associated with the swiped debit/credit card. In step 556, the terminal 502 may transmit a message to determine whether the device 102 is in-range of the terminal 502. If the device 102 does not respond, and/or does not respond with the correct security information (e.g., responds with an incorrect PIN and/or hardware unique key), then, in step 562, the payment may be declined. If the device 102 does respond with the correct security information, then in step 558, the payment may be accepted.

In step 560, the point-of-sale terminal 502 may send a record of the transaction to the device 102 and/or to an account (e.g., an email account) associated with the customer or the device 102 (e.g., the authorization message from the device 102 may include an email address to which the receipt is to be sent). The receipt may be sent via the far-field radio 506, the near-field radio 510, and/or via a network connection (e.g., an Ethernet port of the point-of-sale terminal 502). In an exemplary embodiment of the invention, the receipt may be stored online and a cookie which enables access to the receipt may be sent to the device 102 via the far-field radio 506 and/or the near-field radio 510. For example, the cookie may comprise a unique confirmation number which can be entered into the retail outlet's website to retrieve the receipt.

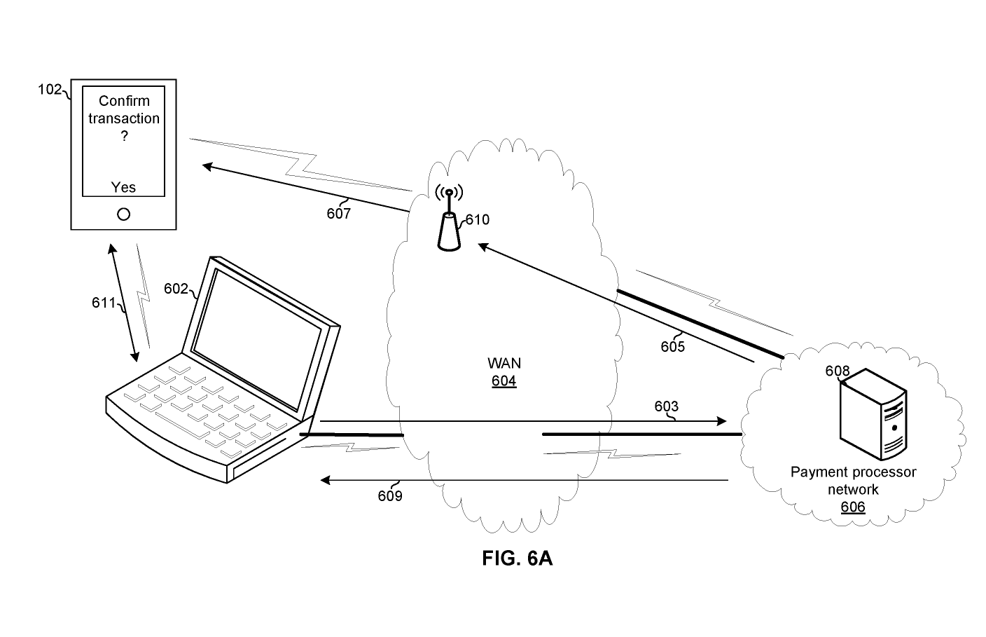

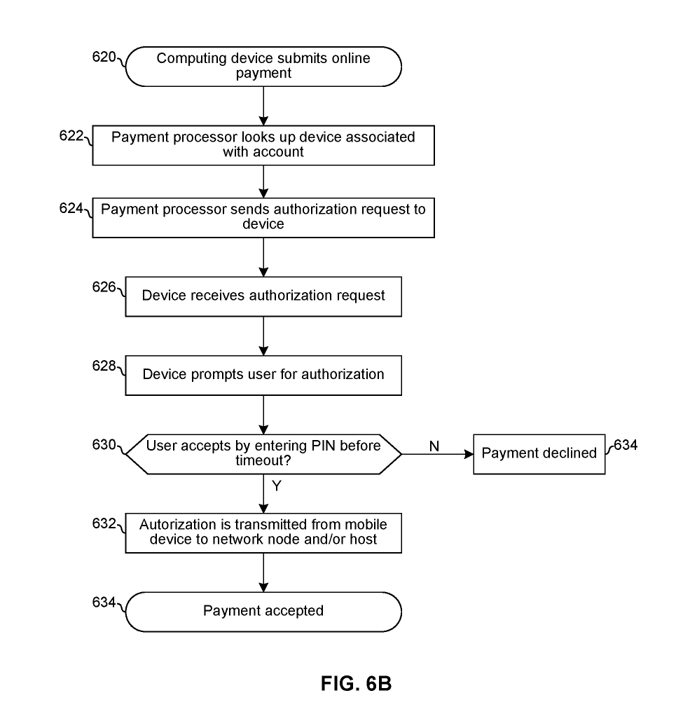

FIG. 6A illustrates and exemplary electronic financial transaction, in accordance with an embodiment of the invention. Shown in FIG. 6A is a computing device 602 connected to a network 606 of a payment processor via a wide area network (WAN) 604. The network 606 may comprise one or more servers 608 (in addition to other network components such as physical links, routers, and switches, not shown).

The WAN 604 may be any network (or plurality of networks) suitable for communicating over a wide area outside of a premises. The WAN 604 may comprise, for example, a digital subscriber line (DSL) network, a cable network, a wireless network, and/or a cellular network. The WAN 604 may comprise one or more wireless access points (WAPs) which supports one or more wireless protocols. In an exemplary embodiment of the invention, the WAP 610 may be similar to, or the same as, the access point 106 (FIG. 1A) and may utilize ISO 18000-7 for wireless communications (the WAP 610 may be referred to as a “DASH7 base station”). Access points 610 of the WAN 604 may, for example, be collocated with cellular base stations.

The computing device 602 may be any device suitable for communicating over the WAN 604. The computing device 602 may be, for example, a laptop or desktop computer, a tablet, or a smartphone.

The server(s) 608 of the network 606 may store information regarding financial accounts. For example, the network 606 may be run by a credit card company and the servers 606 may store information about credit card accounts (e.g., authorized users, associated electronic devices, recent transactions, outstanding balances, etc.).

An exemplary transaction performed by the system depicted in FIG. 6A will now be described with reference to the flowchart of FIG. 6B.

In step 620, the computing device 602 may submit an online payment (depicted as arrow 603) attempting to draw on a particular financial account. The payment may traverse one or more wired, wireless, and/or optical links of the WAN 604. In step 622, a look-up performed in the server(s) 608 may identify the device 102 as being associated with the particular financial account. In step 624, the payment processor may send an authorization request to the device 102.

In an exemplary embodiment of the invention, the authorization request may be sent out-of-band with the WAN 604 via the access point 610. In such an embodiment, the authorization request may traverse one or more wired, wireless, and/or optical links of the WAN 604 in travelling to the WAP 610 (depicted as arrow 605), and may traverse a wireless link from the WAP 610 to the device 102 (depicted as arrow 607).

In another exemplary embodiment of the invention, the authorization request may be sent to the device 602 via the WAN 604 (depicted as arrow 609). The computing device 602 may need to communicate wirelessly with the device 102 (depicted as arrow 611) to, for example, decrypt the authorization request and obtain an authorization code which may then be sent back to the payment processor. For example, the authorization request may be encrypted and the device 602 may need to communicate with the device 102 to decrypt it. The communications with the device 102 may be near-field and/or far-field communications.

In step 626, the device 102 may receive the authorization request. In step 628, the device 102 may prompt a user for authorization of the payment. In step 630, if the user does not authorize the payment (e.g., does not enter a PIN or enters a wrong PIN), then, in step 634, the payment may be declined. If the user does authorize the payment (e.g., by entering the correct PIN in an allotted amount of time), then in step 632 the device 102 may transmit an authorization message back to the access point 610. In step 634, upon receiving the authorization message, the payment processor may accept the payment and send a receipt and/or confirmation code to the computing device 602 and/or the device 102.

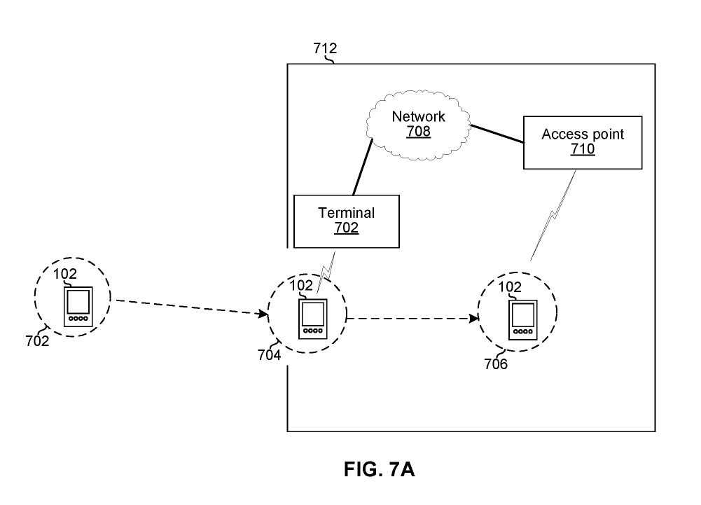

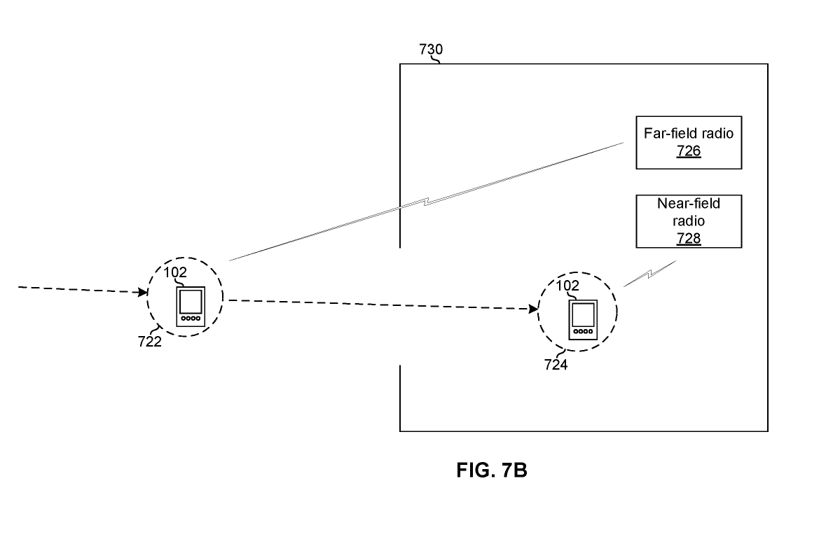

FIG. 7A depicts exemplary communications with a network of a retail outlet, in accordance with an embodiment of the invention. Shown in FIG. 7 a retail outlet 712 comprising a terminal 702 and an access point 710 which are connected to a network 708 of the retail outlet. Each of the terminal 702 and the access point 710 may comprise a near-field radio and/or a far-field radio. The network 708 may comprise a local area network and may be connected to a wide area network (e.g., the Internet).

Depicted in FIG. 7A is the device 102 moving from location 702 to location 704 to location 706. Upon passing through location 706, the terminal 702 may wake up the device 102, and the terminal 702 and device 102 may communicate to register the device 102 with the network 708. The terminal 702 may be located, for example, near an entrance of the retail outlet 712. The communication between the device 102 and the terminal 702 may be far-field and/or near-field. In an exemplary embodiment of the invention in which the device 102 and terminal 702 communicate utilizing far-field communications, the device 102 may prompt its user whether he wants to register with the network. In an exemplary embodiment of the invention in which the device 102 and terminal 702 communicate utilizing near-field communications, a user entering the retail outlet 712 may swipe the device 102 past the terminal 702 if and when he wants to register the device 702 with the network 708.

While the device 102 is inside the retail outlet 712 (e.g., at location 706), the device 102 may receive messages from, and transmit messages to, the network 708 via the access point 710. Messages transmitted from the network 708 to the device 102 may comprise, for example, short-term deals, coupons, and/or other advertisements/offers. A user may respond to these ads and/or offers by, for example, accepting them, declining them, and/or opting to not receive further ads/offers, etc. Messages transmitted from the network 708 to the device 102 may comprise, for example, an alert that an item or service is now ready. For example, the device 102 may be alerted when a table or customer service representative is available in the retail outlet 712.

In an exemplary embodiment of the invention, the device 102 may transmit information about items which the user of the device 102 has interest in (e.g., wants to purchase or wants further information about). Such items may be selected by scanning them with a radio (e.g., near-field radio) and/or reader (e.g., a camera operating as a bar code reader) of the device 102 and/or bumping the device against them. As an example, the list of scanned or bumped items may be placed in a shopping list of items which may be automatically paid for when the device 102 passes the terminal 702 upon exiting the retail outlet 712. As another example, the items may be stored in the user's profile and used to send him coupons or other advertisements (e.g., via email and/or via the access point 710).

FIG. 7B depicts exemplary communications with a network of a retail outlet, in accordance with an embodiment of the invention. Shown in FIG. 7B is a retail outlet 730 comprising a far-field radio 726 and a near-field radio 728. The far-field radio 726 may be similar to or the same as the far-field radio 506 described with respect to FIG. 5A. The near-field radio 728 may be similar to or the same as the near-field radio 510 described with respect to FIG. 5A.

In an exemplary transaction, as the device 102 is approaching the retail outlet 730, and comes into range of the far-field radio 726, (e.g., when it reaches location 722), the device 102 may transmit a communication to the retail outlet 730. For example, the device 102 may place a lunch order. In instances that the far-field radio 726 and the device 102 use a wireless technology that covers a long distance (e.g., DASH7), the order may be placed well in advance of the customer (the user of the device 102) actually arriving at the retail outlet 730. Upon the device 102 arriving at the retail outlet 730, the device 102 may communicate with the near-field radio 728 to confirm pickup of the lunch and to submit payment.

In an exemplary embodiment of the invention, a point-of-sale (POS) purchase may be executed by an ISO 18000-7 (“DASH7”) device acting as a credit or debit card. For example, a user carries a copy of “Moby Dick” to a checkout counter of “Bookstore”. The salesperson scans (or otherwise register) the book into the point of sale terminal and a price of $10.00 (for example) appears on the point of sale terminal visual display. When prompted for payment, the user indicates that he would like to pay using his DASH7-enabled phone. The point of sale terminal then sends a “wakeup” message. The purpose of the wakeup message is two-fold: (1) to alert the nearby DASH7 device that a point-of-sale terminal is seeking to conduct a payment transaction with it; and (2) with the limited range of the wakeup signal (see below), to isolate only one DASH7 device with the desired point-of-sale terminal, rather than to “wake” many DASH7 devices, say, in the entire bookstore. The user then receives a message, via the DASH7 wireless link, on his phone asking if he is ready to pay $10 to “Bookstore” for “Moby Dick.” The user presses the “yes” button on his phone and a “yes” message is transmitted via the DASH7 network back to the DASH7-enabled point of sale terminal. The point of sale terminal then asks for authentication from the user. The user is prompted on his phone to enter a PIN number. The PIN is transmitted (securely) via the DASH7 network to the point of sale terminal. The point of sale terminal does a database lookup to see if the entered PIN is accurate. If accurate, the point-of-sale terminal sends a message to the user's phone “Your payment has been accepted.” The point-of-sale terminal also sends a message to the user “Would you like a receipt” (again using the DASH7 network). The user clicks “yes” and the reply is sent back to the point-of-sale terminal. The point-of-sale terminal generates a receipt electronically which is sent back to the user's handheld terminal. The payment transaction is concluded.

Various exemplary methods for “waking” and “isolating” the “right” device are as follows: (1) Using the “wake on” radio of the DASH7 protocol. In this case, the point-of-sale terminal could send out a very weak signal using the 433 MHz DASH7 air protocol which would awaken a DASH7 device. (2) Transmitting a low frequency (e.g., 125 kHz) wakeup signal with unique item identifier; (3) Transmitting a UHF passive RFID signal (the device may be swiped or placed on (or very-near) the payment terminal) where the device 102 comprises a radio that operates in the UHF band; (4) Transmitting a 13.56 MHz HF RFID signal (the device may be swiped or placed on (or very-near) the payment terminal) where the device comprises a radio that operates in the HF band; (5) “tapping” or “bumping” the device against the terminal in order to create a) a timestamp of the moment of the “tap” and b) an accelerometer (inside the phone) reading that is matched with the timestamp. By matching the timestamps and accelerometer readings of the device and the terminal either a) using a DASH7-based peer-to-peer message regime or b) using cellular or other wide area backhaul to confirm that the device and the terminal are in fact supposed to be exchanging payment info.

In an exemplary embodiment of the invention, a user is browsing Bookstore.com using one of a smartphone, a slate, a tablet, a notebook, a laptop, an e-book reader, or a desktop. The user browses to “Moby Dick” and decide to buy it. The user adds the book to his shopping cart. Upon moving to the shopping cart “page” or screen, the user is prompted for account or payment information. The user selects his payment method (e.g., credit card or electronic check) and enters the payment information (e.g., name, account number, etc.). The account or payment information is then transmitted from the device via a DASH7 network (i.e., out of band with the Internet connection to Bookstore.com). The information may be encrypted. Alternatively, the payment information is sent over the same internet connection via which the site was accessed and then Bookstore.com sends an out-of-band message, via a DASH7 link, requesting authorization.

In an exemplary embodiment of the invention, a user may complete an entire transaction on a DASH7-enabled, powered smartcard which has a display and one or more user controls (e.g., “blister” buttons or other input). The user could purchase goods or services which appear on the display through a series of menu options. For example: the display may show “50” LCD HDTV model #7777” (scroll to next line) “Now available for $1,999” (scroll to next line) “via electronicstore.com” (scroll to next line) “purchase? Y/N” (user presses “Y”) “input passcode” (passcode is input using blister buttons) “passcode OK” (scroll to next line) “confirm purchase of” (scroll to next line) “50” LCD HDTV Model #7777″ (scroll to next line) “Total $2,176.32” (scroll to next line) “Press ‘Y’ to confirm” (User presses ‘Y’) “purchase confirmed.”

In an exemplary embodiment of the invention, acceptance of payment may be contingent on a wireless device being within a determined distance of the place where the payment is being attempted. For example, a user walks into Bookstore and selects a copy of Moby Dick from the shelf. Upon reaching the checkout counter, the user presents his credit card. As part of its anti-fraud measures, the credit card company wants to confirm that the user is in fact the account-holder. Accordingly, the credit card company, via the point-of-sale terminal, “pings” (e.g., via a DASH7 link) the account holder's phone. The user's phone is in-range and replies to the ping, thus verifying that the user of the credit card is the account holder (or at least has the account holder's phone).

Another potential anti-fraud measure is to use a network (e.g., a DASH7 network connecting to the Internet) to update one or more location based services (LBS) like Foursquare or Gowalla, which allow a user to post his or her location to a social networking website or service. An alternative use of these LBS networks is to enable anti-fraud measures. For example, using the DASH network, a user has his Foursquare account automatically “updated” (with or without his intervention) to say “At Bookstore.” The people at the credit card company are able to query John's Foursquare location coordinates—via a Foursquare API—to confirm his presence at the bookstore.

In an exemplary embodiment of the invention a second wireless device (e.g., a powered smartcard) may be paired with a smartphone for authentication and payment purposes. The use of a second wireless device in conjunction with a user's smartphone (or other computing device) can enable an additional layer of authentication. For example, when using a DASH7-enabled, powered smartcard for executing payments transactions, the smartcard can also, via a DASH7 wireless link, “pair” with the user's smartphone directly and, in the event the smartphone is not present for pairing, a central authentication and clearing authority like Visa or a bank can choose to decline the transaction, similar to the anti-fraud application mentioned previously.

A device, such as the device 102, can also be used to assist service businesses to anticipate customer orders before they occur in order to speed processing of anticipated orders. For example, a customer walking down the street decides to stop at his favorite coffee shop to get a latte and a maple oat nut scone. (. Note: this could be extended to a range of intervals before entering the store, e.g., leaving his home, getting into his car, getting on a bus, getting off a bus, entering an area 100 yards from a coffee shop, etc.) As the customer approaches the front door, a wakeup terminal sends a signal to the customer's wireless device (e.g., a smartcard 102 issued by the coffee shop as a “loyalty card”). The customer's wireless device then sends a message (e.g., a 433 MHz UHF DASH7 message) to a reader installed on the premises of the coffee shop. The reader sends a message (via Ethernet, TCP/IP, or any other suitable transport) to a local or centrally-hosted customer relationship management (CRM) application and database that identifies the customer at the front door as John Smith. The system knows details about his past purchasing behavior including his weekday preference for a tall, non-fat latte and a maple oat nut scone. The system sends a message immediately to a barista to begin preparing the non-fat latte. As John walks into the store, another wakeup device stationed on the ceiling or elsewhere nearby provides further confirmation that John has in fact walked into the store and is approaching the point-of-sale counter. This update is also sent to the CRM application and then relayed to the barista, who gets a “confirmation” message that John is actually coming to the point-of-sale counter and that latte preparation should continue apace. The barista or the cashier confirms John's order by greeting him with “Hello John. We have a tall non-fat latte being prepared for you and here is your maple oat nut scone. Will that be all?” John smiles and says “that will be all.” Cashier tells John “That will be $5.15.” John pays and leaves.

In an embodiment of the invention, the transaction may be completed without a cashier and John may be enabled to pick up his drink with automatic payment triggered by a particular event. The trigger event may be, for example: (1) John waving his NFC-enabled smartcard at the point-of-sale terminal; (2) John uses a wakeup mechanism very close to the pickup counter that sends a message from his wireless device to the network saying it's really him and she's going to take her beverage now; (3) a motion sensor on the counter could detect when someone who has not paid takes a drink off the counter but sense John's wireless device (e.g., via a DASH7 link) is there and disables the alarm.

In an exemplary embodiment of the invention, a retail outlet may tag all of its goods with RFIDs and a user's wireless device may scan each item that the user wants to purchase. The user may then walk out the door with a shopping cart full of goods and the wireless device may transmit payment as the user exits the store. For example, the goods may be scanned with a near-field radio of the wireless device and the purchase may be completed with a far-field radio of the wireless device.

In an embodiment of the invention, a user can message ahead with his DASH7-enabled device saying that he wants his order ready to go at a specific time. The long range of DASH7 communications devices means John could potentially order from kilometers away, depending on network coverage.

In an embodiment of the invention, a user of a wireless device may “check in” to products and services uniquely via a DASH7 network. Using the above example of coffee shop again, as John picks up his cup of coffee from the counter, he can automatically check-in to that cup of coffee through the use of a wakeup device at the coffee counter. For example, the wireless device may automatically create a message on the users Foursquare app interface such as “picking up my latte at coffee shop” or other pre-canned or customized message.

In an exemplary embodiment of the invention, a wireless network (e.g., a DASH7 network) may be utilized to send passcodes and other information to a wireless device (e.g. a DASH7-enabled, powered smartcard with a display). The passcode may be used in combination with a credit or debit card in e-commerce or point-of-sale transactions, it may be desirable to transmit one or more of the following via the wireless network: one-time passwords; card balances; currency conversions; loyalty points; transaction log; coupons or promotional codes to be used at the point-of-sale; location of nearest bank branch. Rather than having the passcodes generated automatically within the smartcard itself, the codes could be transmitted wirelessly via the wireless network (e.g., DASH7 network). In place of a numeric passcode, an alphanumeric message can be displayed, via a message from the wireless network, on the smartcard display for use in authentication or for sending messages to the end user. Exemplary messages include: customer retention messages; offers; announcements from the bank; advertisements; coupons; discount codes; cross-promotion of a complementary brand or product; emergency messages; notification of overdraft; notification of a transaction on your account from elsewhere (e.g. auto bill pay, use of another card linked to that account).

One of the weaknesses of location-based services like Foursquare is the ability to “spoof” the system with “phantom” check-ins. However, some users may enjoy the tactile or emotional feedback from checking in consciously, rather than passively as is possible with a DASH7 network. Accordingly, in an exemplary embodiment of the invention, a smartcard may comprise actual “check in” button on the face of a smartcard, whereby users who wish to can simply push this button and trigger a message to the DASH7 network in the location. One exemplary use case for this is where users want to “cloak” their device or otherwise remain anonymous when going into a retail or other location. Users who no longer want to be anonymous, can simply “check in” or “turn on” their DASH7-enabled smartcard with a push of this button. Upon pushing the button, a DASH7 message is created within the smartcard and transmitted, via the DASH7 network, to a cloud or other hosted service like Foursquare.

In an exemplary embodiment of the invention, a smartcard may have a fingerprint reader and/or other biometric reading sensor and the sensor may be used for authentication. For example, a user may place his or her thumb on the biometric reader, which triggers a message via the DASH7 network, with the encrypted information about the fingerprint sent to a central application/database.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for electronic payments and authentication.

Accordingly, the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method comprising:
performing by a first communication device comprising an ISO 18000-7 interface:
receiving a request to accept a payment via said ISO 18000-7 interface;
transmitting, via said ISO 18000-7 interface, a wake-up message to a second communication device comprising an ISO 18000-7 interface;
transmitting, via said ISO 18000-7 interface, an authorization request to said second communication device;
receiving an authorization message from said second communication device; and
deciding whether to accept said payment based on said received authorization message.

2. The method of claim 1, comprising deciding to accept said payment if said authorization message comprises a correct security code.

3. The method of claim 1, comprising deciding to decline said payment if said authorization message does not comprise a correct security code.

4. The method of claim 1 comprising, after accepting said payment, transmitting, via said ISO 18000-7 interface, a cookie to said second communication device, wherein said cookie enables access to a receipt for said payment.

5. The method of claim 1, wherein said second communication device is an ISO 7816 compliant smartcard.

6. The method of claim 1, wherein said first communication device is a point-of-sale terminal in a retail outlet.

7. The method of claim 1, wherein said first communication device is operated by a financial institution.

8. A system comprising:
a first communication device comprising an ISO 18000-7 interface, said first communication device being operable to:
receive, via said ISO 18000-7 interface, a request to authorize a payment;
transmit, via said ISO 18000-7 interface, a search packet requesting a response from a second communication device;
decide whether to authorize said payment based on a response, if any, received from said second communication device.

9. The system of claim 8, wherein said first communication device decides to accept said payment when a response comprising a proper security code is received from said second communication device.

10. The system of claim 8, wherein said first communication device decides to decline said payment when a response comprising a proper security code is not received from said second communication device.

11. The system of claim 8, wherein said first communication device is a smartphone.

12. The system of claim 8, wherein said second communication device is an ISO 7816 compliant smartcard.

13. A method comprising:
performing by a communication device comprising an ISO 18000-7 radio:
registering with a network of a retail outlet upon coming into range of a registration terminal of said network of said retail outlet;
while registered with said network of said retail outlet, communicating with said network of said retail outlet utilizing said ISO 18000-7 radio;
deregistering with said network of said retail outlet upon coming into range of a deregistration terminal of said network of said retail outlet.

14. The method of claim 13, wherein:
said communication device comprises a near-field radio; and
said registering and said deregistering are performed via said near-field radio.

15. The method of claim 13, wherein said communication device is an ISO 7816 compliant smartcard.

16. The method of claim 13, wherein said communicating with said network comprises transmitting a purchase order to said network.

17. The method of claim 13, wherein said communicating with said network comprises transmitting payment information to said network.

18. The method of claim 13, wherein said communicating with said network comprises receiving advertisements from said retail outlet.

19. The method of claim 18, wherein said communicating with said network comprises transmitting responses to said advertisements.

20. The method of claim 13, wherein said communicating with said network comprises uploading information about products viewed or purchased by a holder of said communication device.
